(19) United States
(12) Patent Application Publication
(10) Pub. No.: US 2001/0024503 A1
(43) Pub. Date: Sep. 27, 2001

(54) Entertainment apparatus and loading method for digital information

(76) Inventors: Akiyuki Hatakeyama, Kanagawa (JP); Tsutomu Horikawa, Tokyo (JP)

Correspondence Address: HELFGOTT & KARAS, P.C., EMPIRE STATE BUILDING, 60TH FLOOR, NEW YORK, NY, 10118, US

(21) Appl. No.: 09/797,422

(22) Filed: Mar. 1, 2001

(30) Foreign Application Priority Data
Mar. 2, 2000 (JP) 2000-058045
Feb. 27, 2001 (JP) 2001-052360

(51) Int. Cl. H04N 7/167

(52) U.S. Cl. 380/200

(57) ABSTRACT

The entertainment apparatus comprises a main bus and a subbus, which are connected to each other via a center bus having a queue. A CPU, a memory, an image processor and a DMAC are connected to the main bus. A disk drive, an I/O processor, a sound processor, and a security module are connected to the subbus. A program code, which is compressed and partially encrypted, is recorded on a secondary recording medium. The I/O processor obtains a decryption key from the security module. The I/O processor decrypts digital information read from the secondary recording medium based on the decryption key and decompresses the digital information. The decompressed digital information is written into the memory via the queue using a DMA transfer.

### CROSS-REFERENCE TO RELATED APPLICATIONS

This application is based upon and claims the benefit of priority from the prior Japanese Patent Applications No. 2000-058045, filed Mar. 2, 2000, and No 2001-052360, filed Feb. 27, 2001, the entire contents of which are incorporated herein by reference.

### BACKGROUND OF THE INVENTION

1. Field of the Invention

The present invention relates to an entertainment apparatus capable of executing processing for a game based on digital information recorded on a recording medium such as a CD-ROM (Compact Disk Read Only Memory) or a DVD-ROM (Digital Versatile Disk Read Only Memory), or capable of generating predetermined music and images. More specifically, the present invention relates to a loading mechanism for loading digital information on an internal memory of the entertainment apparatus from an external recording medium.

2. Description of the Related Art

A conventional entertainment apparatus, which is implemented as a computer dedicated to entertainment such as a game, does not comprise a recording medium with a large capacity, which is implemented by a hard disk, in general. Namely, the use of a secondary recording medium having digital information such as a program code for a game, data and the like recorded thereon is indispensable to such entertainment apparatus. A CPU is configured to execute processing for entertainment such as a game based on digital information, which is read from the secondary recording medium and recorded on the memory as required.

In other words, the presence of loading function, which reads digital information from the secondary recording medium such as a CD-ROM and records it on the memory as required, becomes important to the entertainment apparatus.

The loading function can be implemented by use of the CPU provided in the entertainment apparatus. Namely, in a BIOS (Basic Input Output System) or a program for entertainment, there is described a procedure for causing the CPU to read digital information from the secondary recording medium and to record it on the memory of the entertainment apparatus as required, whereby making it possible to implement the loading function. In this case, digital information recorded on the secondary recording medium is generally compressed in view of the reduction in the data capacity and the provision of security. Resultantly, the CPU also executes decompression of data read from the secondary recording medium.

However, the CPU primarily executes entertainment processing. For this reason, it is unfavorable that the CPU is caused to execute reading of data from the secondary recording medium and decompression of data. Namely, there may occur a defect in which processing that the CPU should originally execute is not sufficiently carried out if the CPU is caused to execute excessive processing.

Moreover, from a safety standpoint including the copy protection of digital information and the protection of computer virus infection, due consideration must be given to the entertainment apparatus since the entertainment apparatus may be connected to other recording mediums or networks. Satisfactory consideration of this point is not always given to the conventional entertainment apparatus.

### SUMMARY OF THE INVENTION

The main object of the present invention is to improve an entertainment apparatus that can solve the aforementioned problem.

More specifically, an object of the present invention is to provide the technique for implementing an entertainment apparatus that is capable of executing the reading of a program code from an external recording medium without putting an excessive load on a CUP and that is provided with satisfactory consideration of the security.

According to a first aspect of the present invention, there is provided an entertainment apparatus including a main processor for executing predetermined entertainment processing based on digital information loaded on an internal memory, the apparatus comprising: a loading mechanism including an auxiliary processor for reading information of which at least a part is encrypted from a given recording medium, decrypting the read information to generate the digital information, and loading the generated digital information on the internal memory.

“Digital information” includes a program code, data necessary for executing the program code, various kinds of parameters, and data necessary for executing the reproduction of an image and/or sound.

In the entertainment apparatus of the first aspect, when the digital information is loaded by the loading mechanism, the digital information can be decrypted. Therefore, the high-safe loading becomes possible.

The entertainment apparatus of the first aspect may be arranged to comprise a security module having a decryption key recorded thereon, wherein the auxiliary processor obtains the decryption key from the security module to decrypt the read information.

The entertainment apparatus of the first aspect may be arranged so that the information read from the given recording medium is compressed and encrypted, and the auxiliary processor further executes decompression of the decrypted information. In such entertainment apparatus, since the size of digital information is reduced by compression, time required for loading is decreased, so that high-speed loading becomes possible.

It may be arranged that a queue is provided between the auxiliary processor and the internal memory, and the generated digital information is loaded on the internal memory via the queue by a direct memory access transfer.

It may be arranged that the security module comprises an exchangeable single chip. When higher safety is needed such as a case in which someone cracks cipher, an update of the security module may be carried out by exchanging the single chip.

According to a second aspect of the present invention, there is provided an entertainment apparatus including a main processor for executing predetermined entertainment processing based on digital information loaded on an internal memory, the apparatus comprising: a loading mechanism including an auxiliary processor for reading information of which at least a part is encrypted from a given recording medium; and a security module having a decryption key recorded thereon, for decrypting the information read by the auxiliary processor using the decryption key, wherein the auxiliary processor decompresses the decrypted information to generate the digital information and loads the generated digital information on the internal memory.

In the second aspect, it may be arranged that a queue is provided between the auxiliary processor and the internal memory, and the generated digital information is loaded on the internal memory via the queue by a direct memory access transfer.

It may be arranged that the security module comprises an exchangeable single chip.

According to a third aspect of the present invention, there is provided a semiconductor device provided in an entertainment apparatus including a section for executing predetermined entertainment processing based on digital information loaded on an internal memory, the semiconductor device comprising: means for reading information of which at least a part is encrypted from a given recording medium, decrypting the read information to generate decrypted data, generating the digital information based on the decrypted data, and loading the generated digital information on the internal memory.

According to a fourth aspect of the present invention, there is provided a semiconductor device provided in an entertainment apparatus including an executing section for executing predetermined entertainment processing based on digital information loaded on an internal memory and a decrypting section for decrypting information, the semiconductor device comprising: means for reading information of which at least a part is encrypted from a given recording medium, causing the decrypting section to decrypt the read information in order to obtain decrypted data, generating the digital information based on the decrypted data, and loading the generated digital information on the internal memory.

According to a fifth aspect of the present invention, there is provided a semiconductor device provided in an entertainment apparatus including means for executing predetermined entertainment processing based on digital information loaded on an internal memory, the semiconductor device comprising: means for reading information of which at least a part is encrypted from a given recording medium, decrypting the read information to generate decrypted data, decompressing the decrypted data to generate the digital information, and loading the generated digital information on the internal memory.

According to a sixth aspect of the present invention, there is provided a semiconductor device provided in an entertainment apparatus including an executing section for executing predetermined entertainment processing based on digital information loaded on an internal memory and a decrypting section for decrypting information, the semiconductor device comprising: means for reading information of which at least a part is encrypted from a given recording medium, causing the decrypting section to decrypt the read information in order to obtain decrypted data, decompressing the decrypted data to generate the digital information, and loading the generated digital information on the internal memory.

According to a seventh aspect of the present invention, there is provided a computer program for a computer having a main processor for executing predetermined entertainment processing based on digital information loaded on an internal memory, the computer program causing the computer to execute the steps of: reading information of which at least a part is encrypted from a given recording medium; decrypting the read information to generate the digital information; and loading the generated digital information on the internal memory.

According to a eighth aspect of the present invention, there is provided a loading method adapted to a computer having a main processor for executing predetermined entertainment processing based on digital information loaded on an internal memory, the method comprising the steps of: reading information of which at least a part is encrypted from a given recording medium; decrypting the read information to generate the digital information; and loading the generated digital information on the internal memory by a direct memory access transfer.

### BRIEF DESCRIPTION OF THE DRAWINGS

The above object and other objects and advantages of the present invention will become more apparent upon reading of the following detailed description and the accompanying drawings in which:

FIG. 1 is a configuration view of an entertainment apparatus according to one embodiment of the present invention; and

FIG. 2 is an explanatory view illustrating a procedure for loading digital information according to the embodiment of the present invention.

### DETAILED DESCRIPTION OF THE PREFERRED EMBODIMENT

A preferred embodiment of an entertainment apparatus according to the present invention will be specifically explained with reference to the drawing accompanying therewith.

(Configuration of the Entertainment Apparatus)

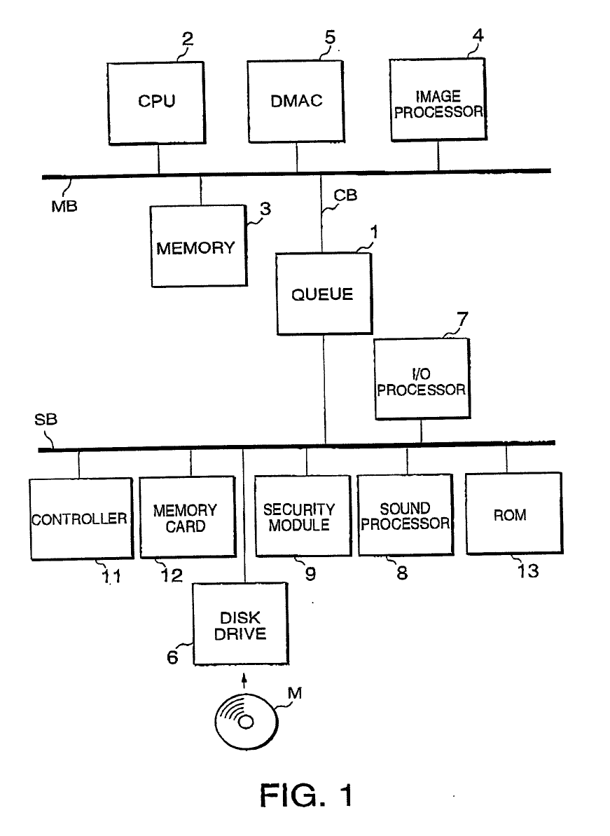

FIG. 1 illustrates a configuration example of the entertainment apparatus according to this embodiment.

This entertainment apparatus is a kind of computer that can be used as, for example, a game apparatus. This entertainment apparatus comprises a main bus MB and a subbus SB, which are connected to each other via a center bus CB having a queue 1. Then, various kinds of function implementing elements are connected to the main bus MB and the subbus SB, whereby configuring the entertainment apparatus.

A CPU 2, a memory 3, an image processor 4 and a DMAC 5 are connected to the main bus MB. A disk drive 6, an I/O processor 7, a sound processor 8, a security module 9, a controller 11, a memory card 12, and a ROM 13 are connected to the subbus SB.

The CPU 2 is a semiconductor device including a microprocessor serving as a main processor. The microprocessor integrally controls the entirety of this entertainment apparatus to makes it possible to execute game processing as one example of entertainment processing and reproduction processing of image and sound based on various data necessary to execute game processing. Prior to the execution of entertainment processing, at the time of starting the entertainment apparatus, the microprocessor reads a boost program from the ROM 13 connected to the subbus SB to execute the boost program such that an OS for implementing a kernel function is boosted.

The memory 3 provides a working area to the CPU 2, and is formed of, for example, a RAM. Digital information, for example, a program code for game processing and data and the like, which is read from a secondary recording medium M to be described later, is recorded on the memory 3 as required and written thereon.

In the explanation given below, as the need for making a distinction between the program code for game processing and data comes about, the former is referred to as “application.”

The image processor 4 generates image data, which is necessary to display a desired image on a display unit (not shown), in cooperation with the CPU 2 based on digital information recorded on the memory 3 as required. Image data includes, for example, polygon data for expressing a game character and the like and texture data having its color information. This image processor 4 is also implemented as one example of the semiconductor device. This image processor 4 specifically comprises a geometry processing unit, a decoder, a rendering processing unit, and a mechanism for displaying generated image data on the display unit. The geometry processing unit performs a coordinate transformation of data read in the course of game processing among digital information recorded on the memory 3 as required. The decoder decodes the content of geometry processing. The rendering processing unit generates image data in frame unit based on data (drawing data) obtained by geometry processing.

The queue 1 temporarily saves digital information exchanged between the main bus MB and the subbus SB. In this embodiment, for example, the queue 1 temporarily saves information, which is exchanged between the memory 3 and the I/O processor 7 or between the memory 3 and the controller 11 or the memory card 12, or between these devices and other device in queue form.

The disk drive 6 mounts the secondary recording medium M composed of, for example, a CD-Rom or a DVD-ROM, and reads digital information including the application and data recorded on this secondary recording medium M. The application that we explain here is a program code, which is used to perform control of the progress of game and reproduction of image and sound according to such control. Data that we explain here is one that is used in reproducing the above image and sound. In this embodiment, it is assumed that the application and data are compressed; thereafter they are partially encrypted and recorded on the secondary recording medium. It is noted that the encryption may be provided to the overall compressed program code and data.

The I/O processor 7 is a semiconductor device functioning as an auxiliary processor with respect to the CPU 2. The I/O processor 7 has a function of controlling the disk drive 6 to read the aforementioned digital information from the secondary recording medium M and to decrypt and/or decompress read digital information after decrypting in cooperation with the security module 9. The I/O processor 7 also has a function of writing information on the queue 1. A program (control program) for implementing these functions at the I/O program is recorded on, for example, the ROM 13, and is executed at the time of booting the entertainment apparatus.

The security module 9 is a semiconductor device, which is formed of an exchangeable single chip, has a dedicated processor, which functions to ensure the safety of the entertainment apparatus, and a memory. This security module 9 stores a decryption key, which is used when the I/O processor 7 performs decrypt processing of digital information. In performing the aforementioned decode processing, the security module 9 sends a necessary decryption key to the I/O processor 7. it is noted that the security module 9 can perform the decrypting of encrypted digital information even singly.

The sound processor 8 is connected to a predetermined speaker (not shown). The sound processor 8 reads data, which corresponds to a sound command sent from the I/O processor 7 or a first DMAC 10 to be described later, from a sound memory (not shown) in which such data is stored, whereby generating sound data to be outputted to the speaker. Accordingly, the speaker outputs a predetermined sound such as a sound effect of the game, BGM with which the image is accompanied, and so on under control of the sound processor 8.

The controller 11 and the memory card 12 are connected to the subbus SB via an input terminal (not shown), and their operations are made possible by execution of the device driver.

The controller 11 works as an input unit for inputting the game player's will to the entertainment apparatus such that, for example, the game player can input a request for cursor movement to upper and lower, and right left directions, or a request for executing some processing.

The memory card 12 is one that has a flash ROM built in a card medium with a given size. In a case where a game is one that generates accumulative data in the course of progress, the memory card 12 is used to record the game data at the time when a player, who enjoys the game, stops the game in progress or ends the game. It is noted that there is a case in which a flash ROM is built in the controller 11 in place of the memory card 12 or together with the memory card 12.

<<Loading method>>

An explanation will be next given of a loading method of digital information in the above-configured entertainment apparatus.

As mentioned above, the entertainment apparatus of this embodiment is designed such that the CPU 2 executes predetermined entertainment processing based on digital information read from the secondary recording medium M and recorded on the memory 3 as required. Accordingly, prior to execution of entertainment processing, loading of digital information from the secondary recording medium M must be carried out in this entertainment apparatus.

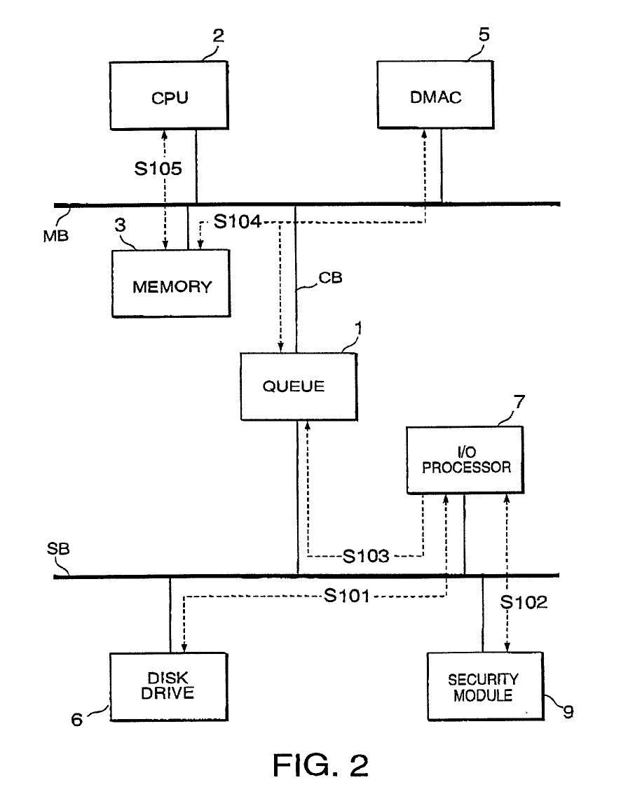

According to this embodiment, this loading is carried out by the procedure illustrated in FIG. 2 under control of the I/O processor 7 and DMAC 5. It is herein assumed that digital information is compressed beforehand and the part thereof is encrypted and recorded on the secondary recording medium M.

When the secondary recording medium M is mounted on the disk drive 6, the I/O processor 7 controls the disk drive 6 to read digital information recoded on the secondary recording medium M (step S101). When the I/O processor 7 finishes reading digital information, the I/O processor 7 gains access to the security module 9 to search a decryption key corresponding to a cryptographic key, and fetches the decryption key (step S102). Then, the I/O processor 7 decrypts the encrypted part using this decryption key and decompresses the compressed part of decrypted information.

The I/O processor 7 sequentially records decompressed digital information on the queue 1 in queue form in a given size (step S103).

Digital information recoded on the queue 1 is sequentially recorded on the memory 3 as required under control of the DMAC 5 (step S104).

When necessary digital information is recorded on the memory 3, the CPU 2 reads the digital information and constructs an environment where predetermined entertainment processing can be executed (step S105).

The above explained the case in which the decrypting and decompression were performed by the I/O processor 7. However, the decrypting may be performed by the security module 9 and the decompression may be performed by the I/O processor 7. In this case, the I/O processor 7 sends digital information read from the secondary recording medium by the above-mentioned procedure to the security module 9 by which the decrypting is executed to obtain information subjected to decrypting.

Moreover, the present invention allows the loading in the case where digital information is subjected to only compression or only encryption and then recorded on the secondary recording medium M. Namely, in the case where digital information is subjected to only compression and then recorded on the secondary recording medium, decrypt processing at the security module 9 is omitted, whereby allowing the loading. In the case where digital information is subjected to only decrypting and then recorded on the secondary recording medium, digital information is recorded on the queue 1 when being decrypted, whereby allowing the loading. The distinction between digital information subjected to only compression and digital information subjected to only decrypting is made possible by interpreting whether data structure of the first part is one that is defined by the I/O processor 7.

Thus, the entertainment apparatus of this embodiment comprises the loading function including the I/O processor 7, which reads the encrypted information from the secondary recording medium M, decrypts encrypted information read to generate digital information, and loads generated digital information on the memory 3, whereby making it possible to perform the loading whose safety is ensured at high speed.

Moreover, the I/O processor 7 is designed to perform the above decrypting in cooperation with the security module 9 formed of exchangeable single chip. For this reason, only security module 9 may be exchanged in order to replace the cryptographic key and the decryption key corresponding thereto. Accordingly, even if the entertainment apparatus is connected to other recording mediums or networks, the copy of digital information and the computer virus infection can be prevented, making it possible to implement the entertainment apparatus with consideration of safety, which has not been sufficiently given to the prior art.

Furthermore, the queue 1 is provided between the I/O processor 7 and the memory 3 as required, so that digital information is recorded on the memory 3 via the queue 1. Decoding and decompression processing and recording of digital information on the memory 3 can be asynchronously carried out. The recording of digital information on the memory 3 is designed to be carried out by DMAC, whereby restraining the increase in the load put on the CPU 2 at the time of loading.

The above embodiment explained the example of the loading mechanism implemented using the entertainment apparatus with the configuration as illustrated in FIG. 1 The present invention, however, an be implemented by causing a general-purpose computer mounting OS thereon read and execute a computer program (application excepting the device driver) ex post facto, in addition the aforementioned embodiment. Moreover, the above loading mechanism can be implemented in cooperation with the processor, one or a plurality of semiconductor devices having a program for providing a given function the processor, and the above computer.

As is obvious from the above explanation, the present invention can provide the entertainment apparatus that is capable of executing the reading of digital information from an external recording medium without putting an excessive load on a main processor and that is provided with satisfactory consideration of the safety.

Various embodiments and changes may be made thereunto without departing from the broad spirit and scope of the invention. The above-described embodiment intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

What is claimed is:

1. An entertainment apparatus including a main processor for executing predetermined entertainment processing based on digital information loaded on an internal memory, the apparatus comprising:
a loading mechanism including an auxiliary processor for reading information of which at least a part is encrypted from a given recording medium, decrypting the read information to generate the digital information, and loading the generated digital information on the internal memory.

2. The entertainment apparatus according to claim 1, further comprising a security module having a decryption key recorded thereon, wherein the auxiliary processor obtains the decryption key from the security module to decrypt the read information.

3. The entertainment apparatus according to claim 1, wherein the information read from the given recording medium is compressed and encrypted, and the auxiliary processor further executes decompression of the decrypted information.

4. The entertainment apparatus according to claim 1, wherein a queue is provided between the auxiliary processor and the internal memory, and the generated digital information is loaded on the internal memory via the queue by a direct memory access transfer.

5. The entertainment apparatus according to claim 2, wherein the security module comprises an exchangeable single chip.

6. An entertainment apparatus including a main processor for executing predetermined entertainment processing based on digital information loaded on an internal memory, the apparatus comprising:
a loading mechanism including an auxiliary processor for reading information of which at least a part is encrypted from a given recording medium; and
a security module having a decryption key recorded thereon, for decrypting the information read by the auxiliary processor using the decryption key,
wherein the auxiliary processor decompresses the decrypted information to generate the digital information and loads the generated digital information on the internal memory.

7. The entertainment apparatus according to claim 6, wherein a queue is provided between the auxiliary processor and the internal memory, and the generated digital information is loaded on the internal memory via the queue by a direct memory access transfer.

8. The entertainment apparatus according to claim 6, wherein the security module comprises an exchangeable single chip.

9. A semiconductor device provided in an entertainment apparatus including a section for executing predetermined entertainment processing based on digital information loaded on an internal memory, the semiconductor device comprising:
means for reading information of which at least a part is encrypted from a given recording medium, decrypting the read information to generate decrypted data, generating the digital information based on the decrypted data, and loading the generated digital information on the internal memory.

10. A semiconductor device provided in an entertainment apparatus including an executing section for executing predetermined entertainment processing based on digital information loaded on an internal memory and a decrypting section for decrypting information, the semiconductor device comprising:
means for reading information of which at least a part is encrypted from a given recording medium, causing the decrypting section to decrypt the read information in order to obtain decrypted data, generating the digital information based on the decrypted data, and loading the generated digital information on the internal memory.

11. A semiconductor device provided in an entertainment apparatus including means for executing predetermined entertainment processing based on digital information loaded on an internal memory, the semiconductor device comprising:
means for reading information of which at least a part is encrypted from a given recording medium, decrypting the read information to generate decrypted data, decompressing the decrypted data to generate the digital information, and loading the generated digital information on the internal memory.

12. A semiconductor device provided in an entertainment apparatus including an executing section for executing predetermined entertainment processing based on digital information loaded on an internal memory and a decrypting section for decrypting information, the semiconductor device comprising:
means for reading information of which at least a part is encrypted from a given recording medium, causing the decrypting section to decrypt the read information in order to obtain decrypted data, decompressing the decrypted data to generate the digital information, and loading the generated digital information on the internal memory.

13. A computer program for a computer having a main processor for executing predetermined entertainment processing based on digital information loaded on an internal memory, the computer program causing the computer to execute the steps of:
reading information of which at least a part is encrypted from a given recording medium;
decrypting the read information to generate the digital information; and
loading the generated digital information on the internal memory.

14. A loading method adapted to a computer having a main processor for executing predetermined entertainment processing based on digital information loaded on an internal memory, the method comprising the steps of:
reading information of which at least a part is encrypted from a given recording medium;
decrypting the read information to generate the digital information; and
loading the generated digital information on the internal memory by a direct memory access transfer.
